(19) United States
(12) Patent Application Publication
(10) Pub. No.: US 2011/0219365 A1
(43) Pub. Date: Sep. 8, 2011

(54) HIGH AND LOW VALUE APPLICATION STATE

(75) Inventors: Leib Adam Foxman, Reading, MA (US); Neil Jacobson, Arlington, MA (US); Eric C. Jewart, Waltham, MA (US); Alp Emre Kanlikilicer, Cambridge, MA (US); John M. Sheehan, Cambridge, MA (US); Jeremy E. Dunker, Boston, MA (US)

(73) Assignee: Microsoft Corporation, Redmond, WA (US)

(21) Appl. No.: 12/717,969

(22) Filed: Mar. 5, 2010

(51) Int. Cl. G06F 9/44; G06F 9/445

(52) U.S. Cl. 717/168; 717/174

(57) ABSTRACT

A set of high value state in application state for a software application can be distinguished from a set of low value state in the application state. For example, a set of heuristics can be run on the application state to distinguish between the set of high value state and the set of low value state. A set of designations that designate the set of high value state in the application state as high value and that designate the set of low value state in the application state as low value can be generated. When processing the application, the high value state can be processed differently than the low value state. The application may be packaged as a virtual application.

### BACKGROUND

Software applications are typically configured with application state. As used herein, application state is application information that can change. For example, application state may include configuration data that is revised as a non-virtual application is installed and/or executed, or configuration data that is revised when a virtual application is instantiated and/or executed. Application state may be processed in various ways, such as being processed during the normal execution of an application, being processed during backup operations, and being processed when moving or servicing an application. As used herein, servicing refers to one or more of various operations that modify an application, such as updating an application, upgrading an application, rolling back an application upgrade or patch, patching an application, etc.

### SUMMARY

The present application is directed to distinguishing between high and low value state for applications. This distinction may yield one or more of various benefits and uses, such as allowing high and low value state to be processed differently. As used herein, high value application state, or high value state, is application state that is identified as being more valuable to preserve for subsequent use with an application. Low value application state, or low value state, is application state that is identified as being less valuable to preserve for subsequent use with an application. For example, high value state may be state the loss of which is more likely to prevent an application from functioning as expected, while low value state may be state the loss of which the loss of which is likely to go unnoticed by the application and its users. For example, high value state may include user data, user preferences, and account information. The loss of such state may cause an application to be broken, or it may cause the application to reset fully or partially to default state. Low value state may include executable files, or particular types of executable files that could be recovered (e.g., from a golden image virtual application package) with the application continuing to function as expected. As another example, low value state may include a log file that is used only for debugging, where the log file could be lost and the application could continue to function as expected. High and low value state may be identified and/or distinguished in one or more of various ways, including running heuristics on application state and receiving user input.

In one embodiment, the tools and techniques can include distinguishing between a set of high value state in application state for a software application and a set of low value state in the application state. The application can be packaged in a virtual application package. As used herein, a package includes the information (files, metadata, etc.) that is taken from packaging of an application and used in deployment to instantiate the application. The package may be split into multiple parts, and some parts may be transmitted in different ways and/or at different times.

In another embodiment of the tools and techniques, application state for an application can be analyzed. A set of designations that designate a set of high value state in the application state as high value can be generated, and a set of designations that designate a set of low value state in the application state as low value can be generated.

In yet another embodiment of the tools and techniques, a set of heuristics can be run on a set of application state to distinguish between a set of units of high value state in a set of application state and a set of units of low value state in the set of application state. High value designations of the units of high value state can be made, and low value designations of the units of low value state can be made.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a block diagram of an environment for implementing high and low value application state.

FIG. 3 is a flowchart of a high and low value application state technique.

FIG. 4 is a flowchart of another high and low value application state technique.

FIG. 5 is a flowchart of yet another high and low value application state technique.

### DETAILED DESCRIPTION

Embodiments described herein are directed to techniques and tools for distinguishing between high and low value application state. Benefits from this distinction may result from the use of various techniques and tools separately or in combination.

Such techniques and tools may include distinguishing between a set of high value state in application state for a software application and a set of low value state in the application state. This high/low distinction may be made by running one or more heuristics on the application state. For example, files including a particular type of executable code may be designated as low value state, and other files may be designated as high value state. Using these high/low value designations, the high value state can be processed differently from the low value state, such as by performing a set of one or more actions to preserve the set of high value state but not performing the set of one or more actions to preserve the set of low value state. For example, high value state may be maintained when servicing or moving an application, while low value state may be discarded or replaced. As another example, high value state may be backed up during a backup operation, and low value state may not be backed up during the operation.

Accordingly, one or more substantial benefits can be realized from the high and low value state distinguishing tools and techniques described herein. The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. For example, the various procedures described herein may be implemented with hardware or software, or a combination of both. Moreover, for the sake of simplicity, flowcharts may not show the various ways in which particular techniques can be used in conjunction with other techniques.

### I. Exemplary Computing Environment

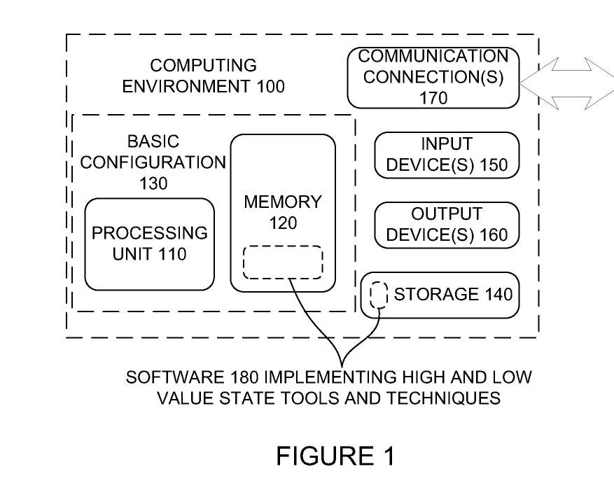

FIG. 1 illustrates a generalized example of a suitable computing environment (100) in which one or more of the described embodiments may be implemented. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing high and low value application state tools and techniques.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. In addition, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include non-transitory computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media. Computer-readable media are any available media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. High and Low Value State System and Environment

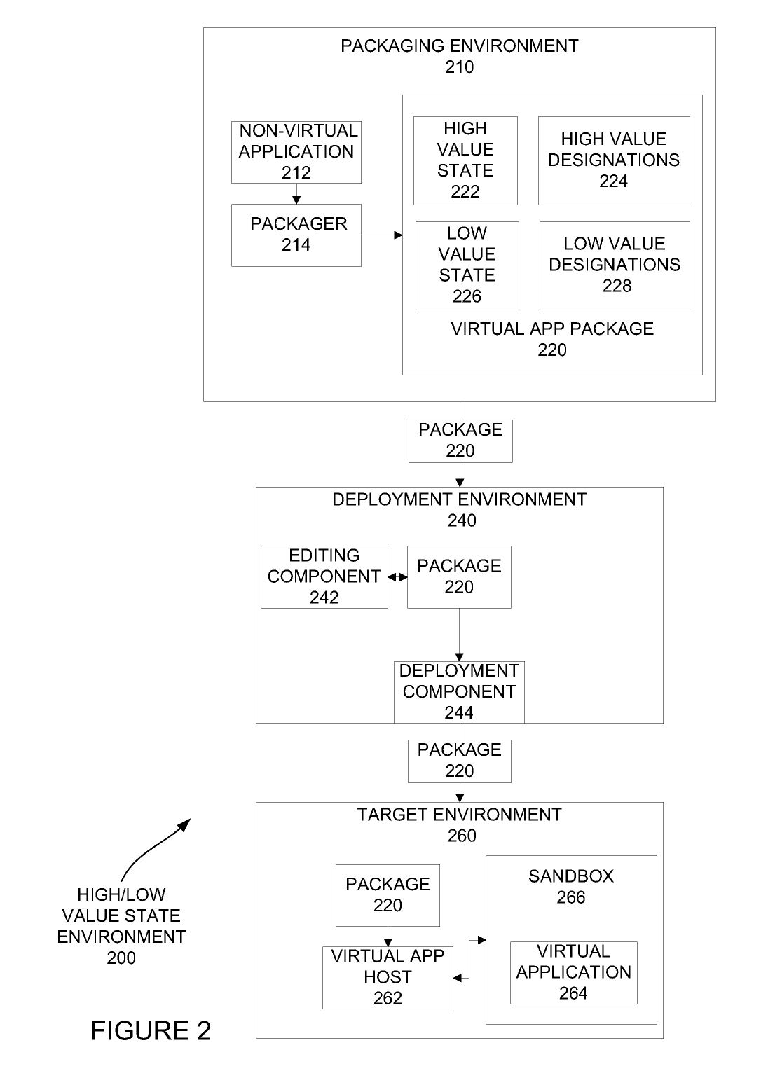

FIG. 2 is a block diagram of a computing environment (200) for implementing high and low value application state tools and techniques. This high/low value state environment (200) can include a packaging environment (210). The packaging environment (210) can include a packager (214), which is a module that can receive a non-virtual application (212) and can package the non-virtual application (212) in a virtual application package (220). For example, the packager (214) may be part of application virtualization software such as Microsoft Application Virtualization (App-V) software. Alternatively, the packager (214) may be part of application virtualization software that is configured for virtualization of server applications. Such server application virtualization software may include features that can handle common ways of starting, stopping, interacting with, and maintaining the lifespan of server applications.

Packaging done by the packager (214) can include determining what state (e.g., files and registry entries) is needed to deploy the application (212), and building the package (220) from this information. As part of packaging to produce the virtual application package (220), the packager (214) can run one or more heuristics on application state for the non-virtual application to distinguish between high value state (222) and low value state (226). For example, in one implementation, during this packaging operation the packager (214) can examine metadata in each file. If the metadata reveals that the file is a particular type of executable code, the file can be considered low value state (226). All other state can be considered high value state (222). Other types of heuristics may be run separately or in combination. For example, heuristics may be based on where files including state for the non-virtual application (212) are stored (e.g., files stored in program directories may be more likely to be low value state). As another example, heuristics may be based on whether the non-virtual application (212) is configured to back up the files (e.g., files to be backed up may be more likely to be high value state). As some other examples, heuristics may be based on when the files are created in the process of installing the application (212) (e.g., files created later may be more likely to be high value state), which process or module of code within a process creates the state and/or reads the state, what storage format is used (file, registry, database, etc.), how access to the state is restricted (e.g., encryption or access control lists), and/or the file extension, date, and/or size of a file that includes the state. Heuristics may be spread out among different components, such as different components of an application virtualization system. For example, registry keys could be evaluated by a virtual registry, and files could be evaluated by a virtual file system. The high value state (222) and the low value state (226) can be included in the virtual application package (220) along with high value designations (224) that designate the high value state (222) as high value, and low value designations (228) that designate the low value state (226) as low value. The packager (214) may switch units of application state between high value state (222) and low value state (226) by editing the corresponding designations (224 and 228). For example, the packager (214) may perform such a switch in response to user input received from a user (e.g., a packaging engineer).

The high and low value designations (224 and 228) may be included in the virtual application package (220), as illustrated in FIG. 2, or they may be generated and maintained in some form that is outside the virtual application package (220). For example, the application state (222 and 226) may include application files packaged in a single application virtualization file, such as a “*.sft” file commonly used in App-V software. Each state file within the application virtualization file can include an attribute that indicates whether the state file is high value or low value. For registry data, designations of high or low values can be stored along with the virtual registry key attributes. Thus, the high and low value designations (224 and 228) can be in the form of attributes of units of state (such as files that include state).

Alternatively, the designations (224 and 228) could be in some other form. For example, the designations (224 and 228) could be in a separate file within the virtual application package (220), or in a separate file outside the virtual application package (220). In addition, the designations could be in the form of included data and/or omitted data. For example, the high value state may include metadata that indicates high value, and the low value state may omit that metadata. In this example, the metadata indicating the high value state can be a high value designation (224) for high value state (222), and the omission of that metadata can be a low value designation (228) for low value state (226).

The package (220) can be passed to a deployment environment (240). In the deployment environment, an editing component (242) can edit the package (220), including the high and low value designations (224 and 228). For example, an administrator at the deployment environment can provide user input, and in response, the editing component (242) can edit the high and low value designations (224 and 228). For example, the editing component may change one or more high value designations (224) to low value designations (228), and/or change one or more low value designations (228) to high value designations (224). A deployment component (244) can deploy the package (220), as edited by the editing component (242), to one or more target environments (260).

The high and low value designations (224 and 228) can be deployed along with the application package (220), either by being deployed as part of the application package (220) or being deployed outside the application package. The editing component (242) and the deployment component (244) may be components in application virtualization software, such as App-V.

In the target environment (260), a virtual application host (262) (such as a client component of the App-V virtualization software) can use the package (220) to instantiate and run the application as a virtual application (264) in a “sandbox” (266) in the target environment (260). The sandbox (266) is a capsule that includes the virtual application (264) and virtual resources to run the virtual application (264) without installing the application as a native application in the target environment (260). The target environment (260) (such as a real or virtual machine) may include multiple sandboxes (266), each encapsulating a virtual application (264). Thus, each such virtual application (264) can run in the target environment (260) without performing a standard installation of the application in the target environment (260). The virtual application host (262) and/or some other component can run one or more heuristics to distinguish high and low value state in the instantiated application in the target environment (260). For example, this may be done for application state that was created in the target environment (260). Of course, such state would not have been previously categorized as high or low value state. In one implementation, this distinguishing in the target environment (260) may include designating any files or other units of state that were created in the target environment as high value state (222). Other heuristics may be run in addition to or instead of this heuristic. For example, many of the packaging-time heuristics discussed above could also be applied in the target environment (260). Other examples may include heuristics based on frequency of access and/or access patterns (written once and read many times versus interleaved reads and writes, etc.). In addition, the high and low value designations (224 and 228) may be edited in the target environment (260) in response to receiving user input.

During some processing of the virtual application (264) in the target environment (260), the high value state (222) can be processed differently from the low value state (226). For example, the application (264) can be serviced (e.g., updated, upgraded, patched, have an upgrade or patch rolled back, etc.). During servicing, the high and low value designations (224 and 228) can be used to determine whether a file is high value state (222) to be preserved or whether it is low value state (226) to be discarded. The high value state (222) can be preserved separately from the application (264) such as by being saved to a separate location, and the servicing can be performed on the virtual application (264). After the servicing is performed, the high value state (222) can be applied to the newly-serviced virtual application (264). Applying the high value state (222) may include transforming at least some of the high value state (222) to a format that is useable by the newly-serviced application (264). For example, a file in the high value state (222) may need to be reformatted to be useable with the application (264) after the application (264) has been upgraded to a new application version. Thus, the virtual application (264) can still use the high value state (222) and function as expected, even after the virtual application (264) has been serviced in a way that would otherwise have lost the high value state (222).

As another example, a backup operation may backup the high value state (222), but not the low value state (226). As yet another example, the virtual application (264) may be moved to a different target environment (260) (e.g., to a different machine, to a different operating system version on the same machine, etc.). As with the application servicing example above, the high value state (222) in the original target environment (260) can be identified with the high value designations (224). The high value state (222) can be preserved, transmitted to the new target environment (260), and re-applied to the virtual application (264) in the new target environment (260) after the virtual application (264) is moved.

The preservation of state in the examples discussed above (servicing, backing up, and moving) can be simplified by applying the preservation technique to the high value state (222), but not to the low value state (226).

The identification and preservation of high value state could be done in environments that differ from the high/low value state environment (200) discussed above. For example, the virtual application package (220) could be deployed directly from the packaging environment (210) to the target environment (260). Indeed, packaging, deployment, and execution of the virtual application may all be done in the same environment. Moreover, the tools and techniques described herein may be applied to an application that is installed and run as a non-virtual application. For example, high and low value state could be distinguished and designated for an installed non-virtual application. The high value state could be treated differently when processing state. For example, in backup operations, the high value state may be backed up but the low value state may not. As another example, in moving the application, the high value state may be preserved to be re-applied to the application after the move, but the low value state may not be preserved and re-applied. As yet another example, in servicing the application, the high value state may be preserved to be re-applied to the application after servicing, but the low value state may not be preserved and re-applied.

### III. High and Low Value State Techniques

Several high and low value state techniques will now be discussed. Each of these techniques can be performed in a computing environment. For example, each technique may be performed in a computer system that includes at least one processor and a memory including instructions stored thereon that when executed by the at least one processor cause the at least one processor to perform the technique (a memory stores instructions (e.g., object code), and when the processor(s) execute(s) those instructions, the processor(s) perform(s) the technique). Similarly, one or more computer-readable storage media may have computer-executable instructions embodied thereon that, when executed by at least one processor, cause the at least one processor to perform the technique.

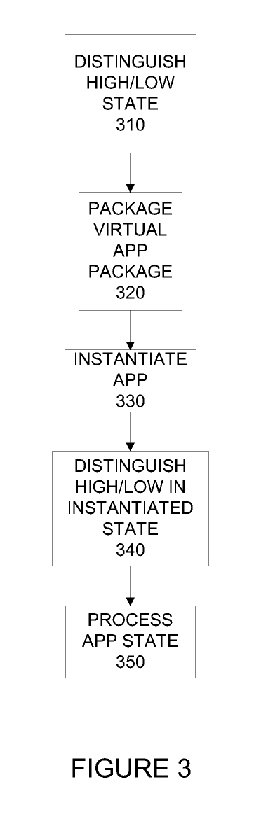

Referring to FIG. 3, a high and low value state technique will be discussed. In the technique, a set of high value state in application state for a software application and a set of low value state in the application state can be distinguished (310), and the application can be packaged (320) in a virtual application package. A set of one or more designations may be generated, where the set designates the set of high value state as high value and designates the set of low value state as low value. For example, distinguishing (310) can include running one or more heuristics. The heuristic(s) may determine whether one or more units of the application state include executable code, such as whether the one or more units include a predetermined type of executable code. Distinguishing (310) may include designating units of application state, such as files, as low value if the units include the predetermined type of executable code, and as high value if the units do not include the predetermined type of executable code. As one example, the heuristic may determine whether a given file is a Portable Execution (PE) image. If the file is a PE image, the file can be considered low value state, and if the file is not a PE image, the file can be considered high value state.

The application may be instantiated (330) in a target environment. Distinguishing and packaging may be done in a packaging computing environment (where the application is packaged) and/or in the target computing environment (where the application is instantiated and executed) after instantiating the application, and distinguishing may be done prior to the packaging being finalized. Thus, the set of high value state can be a set of high value state in the virtual application package and/or a set of high value state in the instantiated application. Likewise, the set of low value state can be a set of low value state in the virtual application package and/or a set of low value state in the instantiated application. Accordingly, the technique may include distinguishing (340) in the target environment between a set of high value state in the instantiated application and a set of low value state in the instantiated application after instantiation has begun.

The technique can further include processing (350) at least a portion of the application state, which can include processing the set of high value state differently from the set of low value state. For example, a set of one or more actions may be performed to preserve the set of high value state but not performed to preserve the set of low value state. This processing can be done in a target environment, and it can be done after the application has been instantiated. For example, processing may include an act that is part of a group that includes servicing the application, performing a backup operation, and/or moving the application.

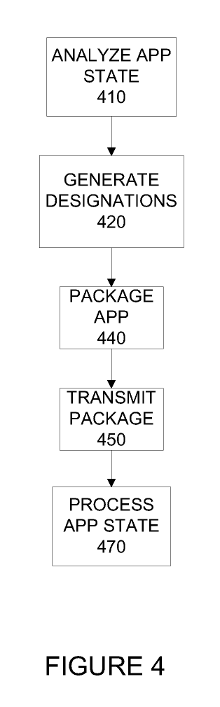

Referring now to FIG. 4, another high and low value state technique will be discussed. The technique can include analyzing (410) application state for an application. A set of one or more designations can be generated (420). This set of designation(s) can designate a set of high value state in the application state as high value and a set of low value state in the application state as low value. For example, the set of designation(s) may include a set of high value designation(s) that designate high value state as high value and a set of low value designation(s) that designate low value state as low value. The technique can also include packaging (440) the application as a virtual application package. The package can be transmitted (450) to a target environment to be instantiated. The virtual application package can include the set of one or more high value designations and the set of one or more low value designations, or those designations can be transmitted separately. In addition, at least a portion of the application state can be processed (470), which can include processing the set of high value state differently from the set of low value state.

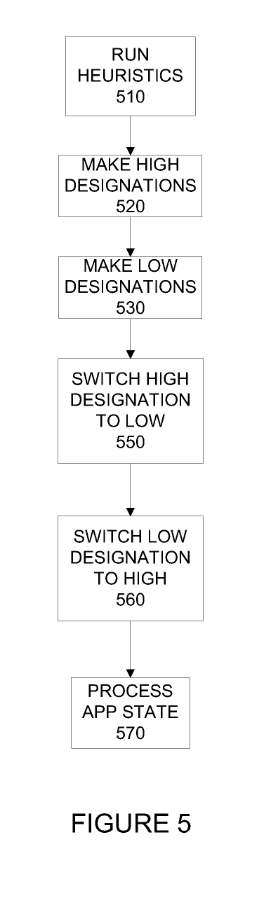

Referring now to FIG. 5, yet another high and low value state technique will be discussed. The technique can include running (510) a set of one or more heuristics on a set of application state to distinguish between a set of one or more units of high value state in the set of application state and a set of one or more units of low value state in the set of application state. One or more high value designations can be made (520). The high value designation(s) can be designation(s) of the unit(s) of high value state. One or more low value designations can also be made (530). The low value designation(s) can be designation(s) of the unit(s) of low value state.

In response to user input, one of the high value designations can be switched (550) to a low value designation. Similarly, in response to user input, one of the low value designations can be switched (560) to a high value designation. Moreover, the technique can also include processing (570) at least a portion of the application state, where the processing can include processing the set of high value state differently from the set of low value state.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A computer-implemented method, comprising:
distinguishing between a set of high value state in application state for a software application and a set of low value state in the application state; and
packaging the application in a virtual application package.

2. The method of claim 1, wherein distinguishing comprises running one or more heuristics on the application state.

3. The method of claim 2, wherein the one or more heuristics determine whether one or more units of the application state include executable code.

4. The method of claim 3, wherein the one or more heuristics determine whether one or more units of the application state include a predetermined type of executable code.

5. The method of claim 4, wherein distinguishing comprises designating one or more units of the application state that include the predetermined type of executable code as low value and designating one or more units of the application state that do not include the predetermined type of executable code as high value.

6. The method of claim 1, wherein the distinguishing and packaging are done in a packaging computing environment, wherein the set of high value state is a set of high value state in the virtual application package, and wherein the set of low value state is a set of low value state in the virtual application package.

7. The method of claim 6, wherein the method further comprises performing the following in a target environment after beginning to instantiate the application in the target environment:
distinguishing between a set of high value state in the instantiated application and a set of low value state in the instantiated application.

8. The method of claim 1, further comprising generating a set of one or more designations that designate the set of high value state as high value and that designate the set of low value state as low value.

9. The method of claim 1, further comprising processing at least a portion of the application state, wherein the processing comprises processing the set of high value state differently from the set of low value state.

10. The method of claim 9, wherein the processing comprises performing a set of one or more actions to preserve the set of high value state but not performing the set of one or more actions to preserve the set of low value state.

11. The method of claim 9, wherein the processing is performed after instantiating the application.

12. The method of claim 9, wherein the processing comprises an act selected from a group consisting of servicing the application, performing a backup operation, moving the application, and combinations thereof.

13. The method of claim 1, wherein:
the set of high value state is a set of high value state in the virtual application package and the set of low value state is a set of low value state in the virtual application package;
the method further comprises:
instantiating the application;
distinguishing between a set of high value state in the instantiated application and a set of low value state in the instantiated application; and
processing the instantiated application, wherein the processing comprises processing the set of high value state in the instantiated application differently from the set of low value state in the instantiated application;
distinguishing between the set of high value state in virtual application package and the set of low value state in the virtual application package comprises running one or more heuristics; and
distinguishing between the set of high value state in the instantiated application and the set of low value state in the instantiated application comprises running one or more heuristics.

14. A computer system comprising:
at least one processor; and
a memory comprising instructions stored thereon that when executed by the at least one processor cause the at least one processor to perform acts comprising:
analyzing application state for an application; and
generating a set of one or more designations that designate a set of high value state in the application state as high value and that designate a set of low value state in the application state as low value.

15. The computer system of claim 14, wherein the acts further comprise processing at least a portion of the application state, wherein the processing comprises processing the set of high value state differently from the set of low value state.

16. The computer system of claim 14, wherein the acts further comprise:
packaging the application as a virtual application package; and
transmitting the virtual application package to a target environment to be instantiated, the virtual application package including the set of one or more designations.

17. One or more computer-readable storage media having computer-executable instructions embodied thereon that, when executed by at least one processor, cause the at least one processor to perform acts comprising:
running a set of one or more heuristics on a set of application state for a software application to distinguish between a set of one or more units of high value state in the set of application state and a set of one or more units of low value state in the set of application state;
making one or more high value designations of the one or more units of high value state; and
making one or more low value designations of the one or more units of low value state.

18. The one or more computer-readable storage media of claim 17, wherein the acts further comprise, in response to receiving user input, switching one of the high value designations to a low value designation.

19. The one or more computer-readable storage media of claim 17, wherein the acts further comprise, in response to user input, switching one of the low value designations to a high value designation.

20. The one or more computer-readable storage media of claim 17, wherein the acts further comprise processing at least a portion of the application state, wherein the processing comprises processing the set of high value state differently from the set of low value state.
